(19) United States
(12) Patent Application Publication
(10) Pub. No.: US 2013/0046856 A1
(43) Pub. Date: Feb. 21, 2013

(54) EVENT-TRIGGERED STREAMING OF WINDOWED VIDEO CONTENT

(71) Applicants: Donald Joong, Montreal (CA); Edoardo Gavita, Laval (CA); Adela Carmen Lebidoff, Montreal (CA)

(72) Inventors: Donald Joong, Montreal (CA); Edoardo Gavita, Laval (CA); Adela Carmen Lebidoff, Montreal (CA)

(73) Assignee: TELEFONAKTIEBOLAGET L M ERICSSON (PUBL), Stockholm (SE)

(21) Appl. No.: 13/210,041

(22) Filed: Aug. 15, 2011

(51) Int. Cl. G06F 15/16

(52) U.S. Cl. 709/219

(57) ABSTRACT

An apparatus herein coordinates streaming of multimedia content from a streaming server to a client device. While the client device is receiving a first multicast stream from the streaming server, the apparatus receives notification of the recent or impending occurrence of a defined event of interest characteristic of the multimedia content in a second multicast stream. Responsive to receiving such notification, the apparatus directs the streaming server to stream to the client device a third stream whose video content comprises windowed video content of both the first and second multicast streams. This windowed video content comprises video content from the first and second multicast streams arranged in respective windows. Such event-triggered streaming thus enables a user of the client device to simultaneously watch both the first and second streams, as desired, by efficiently receiving only a single third stream.

### TECHNICAL FIELD

The present invention generally relates to methods and apparatus for streaming multimedia content to a client device, and particularly relates to event-triggered streaming of windowed video content to the client device.

### BACKGROUND

Multimedia content has traditionally been delivered using broadcast technology. Broadcast technology delivers all multimedia content to every user, and each user simply tunes into the desired content. Delivering content in this way requires considerable network resources, especially as multimedia content options increase.

In that regard, increasing demand for multimedia content has intensified the appeal of using multicast technology. Rather than delivering all multimedia content to every user as with broadcast, multicast delivers only desired content to each user. Moreover, those users demanding the same multimedia content receive the same multicast stream and thus efficiently share the network resources used to deliver that stream.

Known streaming approaches nonetheless deliver multiple multicast streams to those users simultaneously desiring the multimedia content of all of those streams. For example, the approaches would deliver two separate multicast streams to a user desiring to watch a movie while also watching a hockey game. The user's television receiver, mobile device, set-top-box, or other client device receives these separate multicast streams and arranges the content for simultaneous viewing. The client device may arrange the content, for instance, as a picture-in-picture.

These approaches often prove inadequate and inconvenient, especially in cases where a user is primarily interested in one multicast stream and is only partially interested in another multicast stream. For example, a user may primarily desire to watch a movie, but may also desire to selectively watch goals or fights as they occur in a hockey game. Because the user cannot predict if or when those goals or fights will actually occur, the user must continually receive and display the hockey game in conjunction with the movie; otherwise, the user will most likely miss seeing those events of interest. Continuous display of the hockey game, however, proves disruptive because it obstructs or otherwise impedes viewing of the movie.

### SUMMARY

Teachings herein advantageously include event-triggered streaming of windowed video content to a client device. The client device, or some network node, receives notifications when defined events of interest occur in a particular multicast stream that is not currently being streamed to the client device. The notifications trigger network-side combining of that stream's video content with the video content of a multicast stream that is currently being streamed to the client device. Windowed video content resulting from this combination of the two streams' content is efficiently streamed to the client device, via a single unicast or multicast stream.

More particularly, embodiments herein include a method for coordinating streaming of multimedia content from a streaming server to a client device. Such method may be implemented by the client device itself, or may be implemented by an application server in the network. Regardless, while the client device is receiving a first multicast stream from the streaming server, the method includes receiving notification of the recent or impending occurrence of a defined event of interest characteristic of the multimedia content in a second multicast stream. Responsive to reception of that notification, the method includes directing the streaming server to stream to the client device a third stream whose video content comprises windowed video content of both the first and second multicast streams.

As used herein, windowed video content comprises video content from multiple streams arranged in respective windows. In a picture-in-picture embodiment, for example, the video content from one stream is arranged in an inlet window that overlays the window within which the video content from another stream is arranged. In a picture-by-picture embodiment, on the other hand, the video content from the streams is arranged into non-overlapping, adjacent windows. Regardless, because the windowed video content combines video content from both the first and second multicast streams, the user of the client device will be able to simultaneously watch both streams simply by receiving a single third stream.

Embodiments herein also include a method implemented by a streaming server for streaming multimedia content to a client device. While streaming a first, but not a second, multicast stream to the client device, the method includes receiving a command that directs the streaming server to stream to the client device a third stream whose video content comprises windowed video content of both the first and second multicast streams. Responsive to the command, the method includes obtaining the video content of the third stream from a video content combiner in the network. Finally, the method includes streaming the third stream to the client device.

In some embodiments, the streaming server unconditionally streams the third stream to the client device as a unicast stream. In other embodiments, the streaming server selectively streams the third stream to the client device as either a unicast stream or a multicast stream. The decision of whether the third stream is to be delivered as a unicast stream or a multicast stream may be based on the number of client devices demanding the third stream. Indeed, more than one client device currently receiving the first stream may be interested in the same events in the second stream, and thus demand the third stream at the same time. If this is the case, the third stream is delivered using multicast rather than unicast.

The decision between unicast or multicast for the third stream may be made by either the application server or the streaming server. Where the decision is made by the application server, the application server may store subscriptions in memory for the client devices served by the application server. This way, the application server may determine the number of client devices that have indicated interest in the defined event associated with the received notification by inspecting the subscriptions stored in memory for each of those devices. In embodiments where the decision is made by the streaming server, however, the streaming server does not have access to the subscriptions of the client devices. Despite this, the streaming server monitors the number of client devices demanding the third stream. If the streaming server has been commanded to deliver the third stream to at least a threshold number of client devices, the streaming server delivers the third stream as a multicast stream.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a content streaming system configured for event-triggered streaming of windowed video content to a client device, according to one or more embodiments.

FIG. 2 is a block diagram of an apparatus configured to coordinate streaming of multimedia content to a client device, according to one or more embodiments.

FIG. 3 is a block diagram of a streaming server configured to stream multimedia content to a client device, according to some embodiments.

FIG. 4 is a call flow diagram illustrating the application server coordinating event-triggered streaming of windowed video content according to at least one embodiment.

FIG. 5 is a call flow diagram illustrating the client device coordinating event-triggered streaming of windowed video content, with the assistance of the application server, according to at least one embodiment.

FIG. 6 is a call flow diagram illustrating the client device coordinating event-triggered streaming of windowed video content, without the assistance of the application server, according to at least one embodiment.

FIG. 7 is a call flow diagram illustrating the client device coordinating event-triggered streaming of windowed video content, with the assistance of the streaming server, according to at least one embodiment.

FIG. 8 is a logic flow diagram of a method implemented by an apparatus for coordinating streaming of multimedia content to a client device, according to one or more embodiments.

FIG. 9 is a logic flow diagram of a method implemented by a streaming server for streaming multimedia content to a client device, according to one or more embodiments.

### DETAILED DESCRIPTION

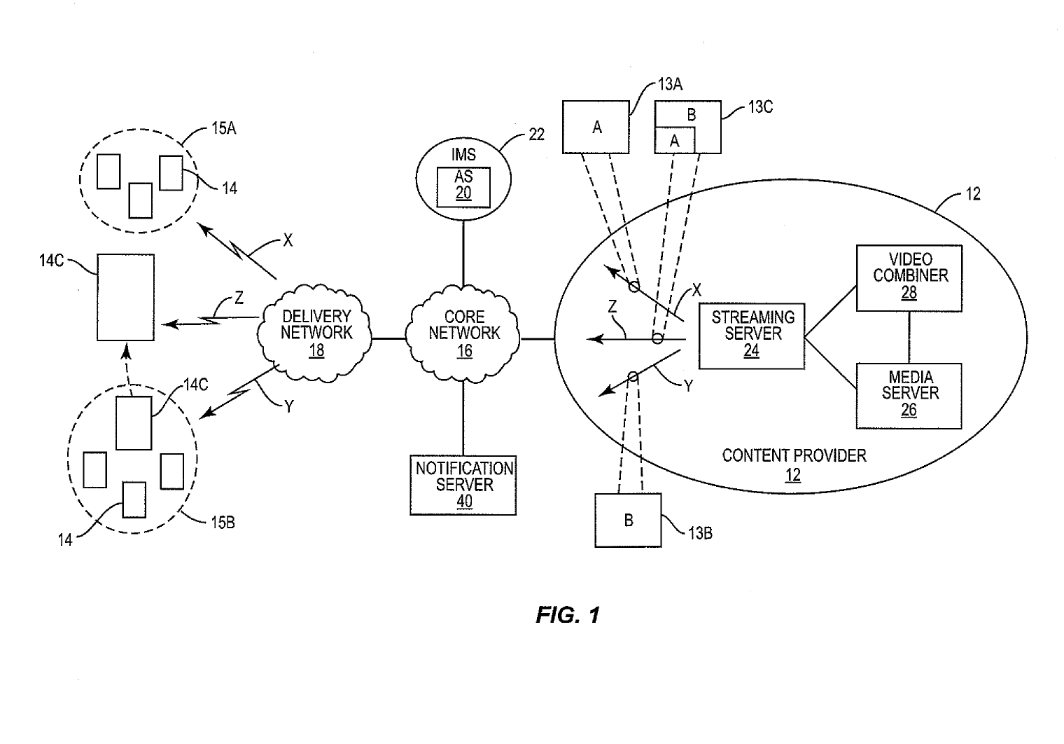

FIG. 1 illustrates a content streaming system 10 for streaming multimedia content from a content provider 12 to client devices 14. The content provider 12 streams the content to client devices 14 via a core network 16 and a delivery network 18. An application server (AS) 20 within an Internet Protocol (IP) Multimedia Subsystem (IMS) 22 coordinates this streaming as IPTV middleware. The AS 20 may, for instance, present client devices 14 with an electronic service guide (ESG) that indicates the multimedia content available from the content provider 12. Then, upon a given client device's selection of desired multimedia content, the AS 20 may assist the client device 14 to establish a media session with the content provider 12 for delivery of the selected content.

The content provider 12 specifically includes a streaming server 24, a media server 26, and a video content combiner 28. The streaming server 24 obtains multimedia content from the media server 26 and/or the video content combiner 28, and then delivers that content to client devices 14 via unicast and/or multicast. As shown, for instance, the streaming server 24 obtains multimedia content 13A and 13B from the media server 26 for delivery to the client devices 14. The streaming server 24 delivers multimedia content 13A to a group 15A of client devices 14 by streaming a multicast stream X to that group 15A. Meanwhile, the streaming server 24 delivers multimedia content 13B to a different group 15B of client devices 14 by streaming a multicast stream Y to that group 15B.

Although client device 14C is receiving stream Y, the device's user is nonetheless partially interested in the multimedia content 13A of stream X. Specifically, the device's user is really only interested in certain events characteristics of the multimedia content 13A of stream X. For example, where the multimedia content 13A depicts a hockey game, the user may only be interested in watching the game if and when goals are scored. As another example, where the multimedia content 13A depicts a reality competition, the user may only be interested in watching the competition when the competition's results are announced.

To advantageously accommodate the user's preference in this regard, the system 10 presents the user with a list of defined events characteristic of the multimedia content 13A. In some embodiments, for example, the AS 20 presents such a list to the user via the ESG. Presented with such a list, the user indicates interest in one or more of those defined events by selectively subscribing the client device 14C to those events. The user's interests in this regard may be stored as a subscription in either the AS 20 or the client device 14C.

The user may then control the device 14C to receive only multimedia content 13B, without fear of missing defined events of interest associated with multimedia content 13A. Indeed, when one of these defined events occurs or is about to occur, the system 10 automatically directs the streaming server 24 to stream a combination of multimedia content 13A and 13B to the client device 14C. Notably, the system 10 directs the streaming server 24 to stream this combination to the client device 14C as a single unicast or multicast stream.

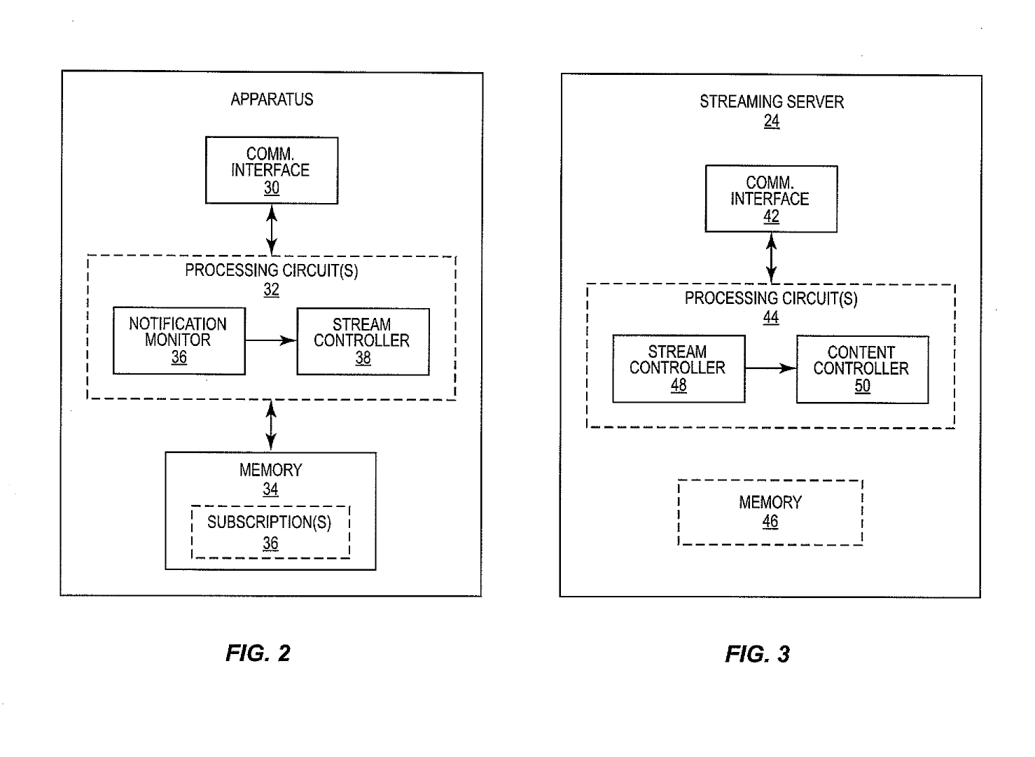

FIG. 2 illustrates additional details for coordinating this streaming of the combination. As shown in FIG. 2, an apparatus (which may be AS 20 or client device 14C) includes a communications interface 30, one or more processing circuits 32, and a memory 34. The communications interface 30 is configured to communicatively couple the apparatus to the streaming server 24. The one or more processing circuits 32 include a notification monitor 36 and a stream controller 38. The notification monitor 36 is configured, while the client device 14C is receiving multicast stream Y from the streaming server 24, to receive notification of the recent or impending occurrence of one of the defined events of interest characteristic of the multimedia content 13A in multicast stream X. In at least some embodiments, for instance, the notification monitor 36 receives such notification from a notification server 40 using the Session Initiation Protocol (SIP) or the Hypertext Transfer Protocol (HTTP). Regardless, the stream controller 38 is configured, responsive to the notification monitor 36 receiving the notification, to direct the streaming server 24 to stream to the client device 14C a stream Z whose video content comprises windowed video content 13C of both multicast streams X and Y.

As shown in FIG. 1, this windowed video content 13C comprises video content 13A and 13B from streams X and Y arranged into distinctive windows. In a picture-in-picture embodiment, for example, the video content 13A from stream X is arranged in an inlet window that overlays the window within which the video content 13B from stream Y is arranged. In a picture-by-picture embodiment, on the other hand, the video content 13A and 13B is arranged into non-overlapping, adjacent windows. Regardless, because the windowed video content 13C combines video content from both streams X and Y, the user of client device 14C will be able to simultaneously watch both streams X and Y simply by receiving stream Z.

FIG. 3 illustrates corresponding details of the streaming server 24. The streaming server 24 includes a communications interface 42, one or more processing circuits 44, and a memory 46. The one or more processing circuits 44 in turn include a stream controller 48 and a content controller 50.

While the streaming server 24 is streaming multicast stream Y to the client device 14C, the stream controller 48 is configured to receive a command that directs the streaming server 24 to deliver stream Z to the client device 14C. Again, stream Z has video content that comprises windowed video content 13C of both streams X and Y.

In this regard, the content controller 50 is configured, responsive to the received command, to obtain the video content of stream Z from the video content combiner 28. The content controller 50 may, for instance, direct the video content combiner 28 to retrieve the video content 13A and 13B of streams X and Y from media server 26, and to combine the retrieved content to dynamically generate windowed video content 13C. Regardless, the communications interface 42 is thereafter configured to stream the stream Z to the client device 14C.

In some embodiments, the streaming server 24 unconditionally streams stream Z to the client device 14C as a unicast stream. In other embodiments, the streaming server 24 selectively streams stream Z to the client device 14C as either a unicast stream or a multicast stream. The decision of whether stream Z is to be delivered as a unicast stream or a multicast stream may be based on the number of client devices 14 demanding stream Z. Indeed, more than one client device 14 in group 15B may be interested in the same events in stream X, and thus demand stream Z at the same time as client device 14C. If this is the case, it would be more efficient to delivery stream Z using multicast rather than unicast.

The decision between unicast or multicast for stream Z may be made by either the AS 20 or the streaming server 24 itself. Where the decision is made by the AS 20, the AS 20 may store subscriptions 36 in memory 34 for the client devices 14 served by the AS 20. This way, the AS's stream controller 38 may determine the number of client devices 14 that have indicated interest in the defined event associated with the received notification by inspecting the subscriptions stored in memory 34 for each of those device 14. If at least a threshold number of client devices 14 have subscribed to that defined event, and are also currently receiving stream Y, the stream controller 38 is configured to direct the streaming server 24 to deliver stream Z as a multicast stream. If this threshold number is not met, though, the stream controller 38 is configured to direct the streaming server 24 to delivery stream Z to each device 14 as a unicast stream.

In other embodiments, the decision between unicast and multicast is made by the streaming server 24. The streaming server 24 does not have access to the subscriptions of the client devices 14, so the server 24 cannot make its decision in the same way as described above with respect to the AS 20. Despite this, the streaming server 24 monitors the number of client devices 14 demanding stream Z. If the streaming server 24 has been commanded to deliver stream Z to at least a threshold number of client devices 14, the communications interface 42 is configured to deliver stream Z to the client device 14C as a multicast stream. Otherwise, if the number of client devices 14 demanded stream Z is less than the threshold number, the communications interface 42 is configured to deliver stream Z as a unicast stream.

Note that, irrespective of whether the stream Z is sent as unicast or multicast, the particular video content of the stream Z may depend in large part on the particular event associated with the notification. In this regard, events may be defined for subscription at any level of detail. For example, events may be broadly defined in terms of a single content-based criteria, or narrowly defined in terms of multiple content-based criteria. Broadly defined events may include, for instance, a goal scored in a game, an accident in a race, a final minute of a game, or the announcement of a competition's results. Narrowly defined events, on the other hand, may include a goal scored by a particular player, an accident involving a particular racer, a final minute of a game that has a score within a pre-determined margin, or the announcement of a competition's results where there are less than a per-determined number of contestants remaining.

The breadth of an event definition may also depend on whether or not the definition is program-specific. In this regard, the multimedia content of a multicast stream often comprises a sequence of multimedia programs. Event definitions for a stream may be either program-independent or program-specific. Program independent event definitions apply across different programs of a multicast stream, meaning that a notification of that event will be triggered regardless of the program in which it occurred. As an example, consider a multicast stream whose content comprises a sequence of different hockey games. A program independent event definition may trigger a notification any time a goal is scored in that multicast stream, regardless of the particular hockey game in which that goal was scored. Program-specific event definitions on the other hand apply only to a particular program of a multicast stream. A notification of this event will be triggered only if the event occurs in the defined program, not if the event occurs in a different program. Continuing the hockey example, a program specific event definition may trigger a notification only when a goal is scored in a particular hockey game, not when a goal is scored in a different hockey game.

Further, events may be generally classified as being either predictable or unpredictable. Predictable events typically occur at a time that is approximately known, while unpredictable events can occur at any time. An example of a predictable event is the last 5 minutes of a regularly scheduled program. By contrast, an example of an unpredictable event is the scoring of a goal or touchdown. Note that the level of detail with which a particular event is defined may affect the predictability of that event.

The system 10 accounts for the predictable or unpredictable nature of a defined event by selectively generating the windowed video content 13C to include either real-time or recorded video content of the multicast stream X. More particularly, if a received notification indicates that a defined event in stream X has occurred in the recent past, meaning that the event was unpredictable, a control command is sent to the streaming server 24 instructing that the windowed video content 13C is to include recorded video content of stream X. The streaming server 24 in turn directs the video content combiner 28 to generate the windowed video content 13C using recorded content of stream X, in accordance with that control command. In this way, the windowed video content 13C simulates an “instant-replay” with recorded video content of stream X, while providing uninterrupted real-time streaming of stream Y's video content.

Otherwise, if a received notification indicates that occurrence of a defined event in stream X is impending, meaning that the event was predictable, a control command is sent to the streaming server 24 instructing that the windowed video content 13C is to include real-time video content of stream X. The streaming server 24 in turn directs the video content combiner 28 to generate the windowed video content 13C in accordance with that control command. Here, the windowed video content 13C thus provides real-time streaming of both X and Y's video content.

In the above embodiments, the AS 20 or client device 14C unconditionally directs the streaming of stream Z responsive to receiving notification of an event to which the device 14C has subscribed. In other embodiments, though, one or more trigger rules, e.g., specified in the device's subscription 36, condition performance of this direction. One such trigger rule may condition direction on a classification of the multimedia content 13B being streamed to the client device 14C when the notification is received. The trigger rule, for instance, may trigger the direction if the notification is received while the client device 14C is receiving multimedia content 13B classified as a sports game, but not trigger the direction if the content 13B is classified as a movie. Another trigger rule may condition direction on a classification of the multimedia content 13A associated with the notification, and/or its relation to multimedia content 13B.

Still other trigger rules condition the direction on a time at which the notification is received. For instance, the trigger rules may trigger the direction only during certain times of the day or year. These conditions prove particularly useful for seasonal or special multimedia content 13A. As one example, the conditions may trigger the direction only during those times of the year that hockey playoffs are ongoing; that is, the direction is suppressed during the regular hockey season.

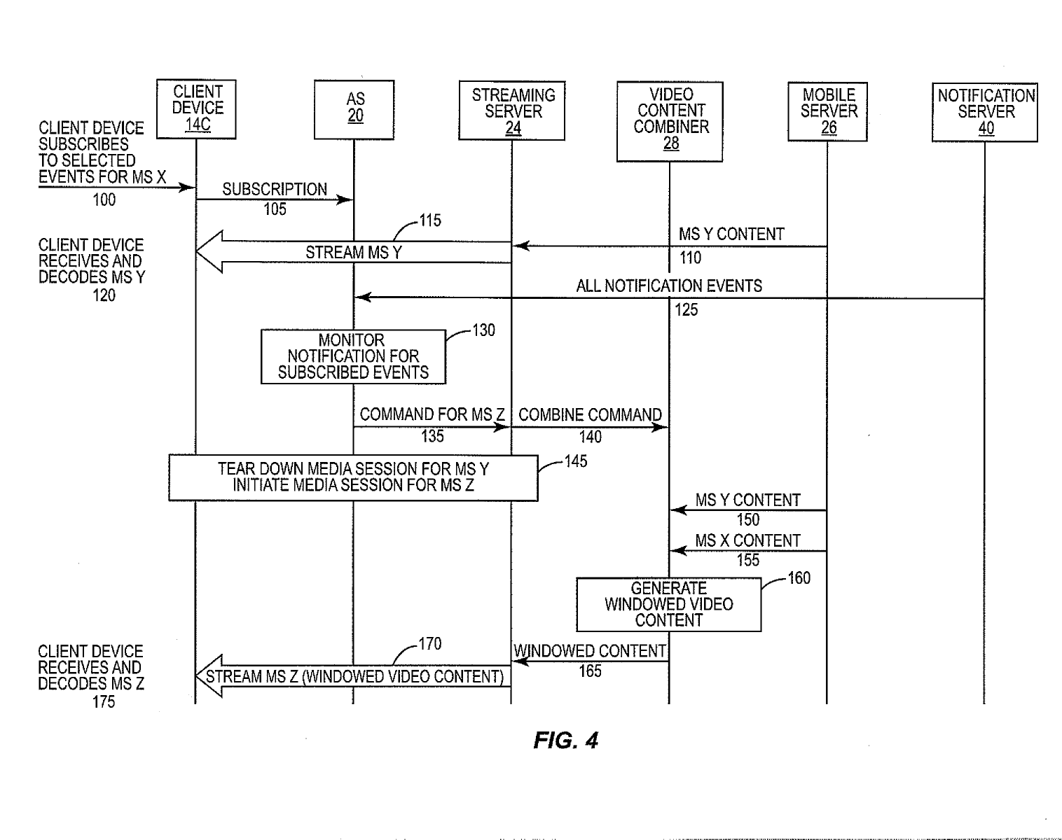

As suggested above, either the AS 20 or the client device 14C itself may be the apparatus that is depicted in FIG. 2 and that triggers streaming of stream Z based on event notifications. FIGS. 4-7 illustrate different embodiments in this regard, where the term multicast stream has been abbreviated for convenience as “MS.”

FIG. 4 depicts an embodiment where the AS 20 autonomously triggers streaming of stream Z based on subscriptions 36 stored in memory 34 of the AS 20. Specifically, the AS 20 presents the client device 14C with a list of defined events characteristic of the multimedia content 13A of stream X. Upon user selection of those events that are of interest to him or her (Step 100), the client device 14C sends the AS 20 a subscription 36 to the selected events of interest (Step 105). The AS 20 correspondingly receives the subscription 36 from the client device 14C and stores the subscription in memory 34.

At some point before or after the client device 14C provides this subscription 36 to the AS 20, the AS presents the client device 14C with a list of the multimedia content available from the content provider 12, e.g., via the ESG. The user selects to receive multimedia content 13B and the AS 20 coordinates with the streaming server 24 for providing the client device 14C with that content 13B. Such coordination may entail, for instance, assisting in the establishment of a multimedia session between the streaming server 24 and the client device 14C. With any such session established, the streaming server 24 retrieves the multimedia content 13B from the media server 26 (Step 110) and delivers that content 13B to the client device 14C through multicast stream Y (Step 115). The client device 14C receives and decodes this stream Y for playback of the multimedia content 13B (Step 120).

While the client device 14C receives stream Y, the notification server 40 pushes notifications of any defined events associated with stream X to the AS 20 (Step 125). Depending at least in part on whether a given defined event is predictable or unpredictable, an event notification for that event may respectively indicate either that the event is about to occur or that the event has just occurred in the recent past. The event notifications pushed to the AS 20 thus generally indicate the recent or impending occurrence of the defined events in near real-time. For example, for live streaming of a sports game, an authoring tool or other interface may be used by a person at the sports game to generate event notifications as the corresponding events occur. In this regard, the event notifications may indicate any number of details about the events to which they relate. In some embodiments, for instance, an event notification includes a timestamp that references a time at which the event occurred or is about to occur in the multimedia stream X, and also includes an event type or definition that distinguishes the notified event from other defined events.

With event notifications being pushed to the AS 20 in this way, the AS 20 monitors the notifications in relation to the subscription 36 for the client device 14C (Step 130). That is, the AS 20 monitors the notifications for the recent or impending occurrence of one of the defined events of interest to which the client device 14C has subscribed. Responsive to notification of such occurrence, the AS 20 sends a command to the streaming server 24 that directs the server 24 to deliver windowed video content 13C (i.e., stream Z) to the client device 14C (Step 135). In doing so, the AS 20 may indicate whether that windowed video content 13C is to include recorded or real-time video content of stream X, depending on whether the received notification indicated the recent or impending occurrence of the defined event. The AS 20 may also identify the multimedia session over which the streaming server 24 has been streaming stream Y to the client device 14C. This way, the streaming server 24 may tear down that session and initiate establishment of a new session for streaming of stream Y to the client device 14C (Step 145).

Note also that, as discussed above, the AS 20 may decide whether stream Z is to be streamed as a unicast or multicast stream. In this case, the AS bases the decision at least in part on the number of client devices 14 that, like device 14C, have subscribed to the notified event. If at least a threshold number of devices 14 have subscribed to the notified event, and have also been receiving stream Y, then the AS 20 decides that stream Z is to be streamed as a multicast stream. The AS 20 indicates this to the streaming server 24 when sending the command for stream Z at Step 135. In doing so, the AS 20 may also establish a multicast address to which the stream Z is to be sent, and indicate this multicast address to both the streaming server 24 and the client devices 14, including device 14C, that are to receive stream Z. Conversely, if this threshold number of client devices 14 is not met, the AS 20 decides that stream Z is to be streamed as a unicast stream. The AS 20 establishes a unicast address to which the stream is to be sent, and indicates that address to both streaming server 24 and the client device 14C.

Regardless of these particular details, when the streaming server 24 receives the command from AS 20 for windowed video content 13C, the streaming server 24 responds by obtaining that windowed video content 13C from the video content combiner 28. In this regard, the streaming server 24 sends a command for the windowed video content 13C to the video content combiner 28, including an indication of whether the windowed video content 13C is to include recorded or real-time video content of stream X (Step 140). The video content combiner 28 correspondingly retrieves the video content 13A, 13B of streams X and Y (Steps 150 and 155), and combines that retrieved content to dynamically generate the windowed video content 13C (Step 160). The video content combiner 28 then provides the generated windowed video content 13C to the streaming server 24 (Step 165).

Having obtained windowed video content 13C from the video content combiner 28, the streaming server 24 encapsulates that content 13C on a single unicast or multicast stream Z. The streaming server 24 then delivers stream Z to the client devices 14C over an established media session (Step 170). This way, even though the client device 14C receives and decodes a single stream Z (Step 175), the client device 14C will nonetheless simultaneously display video content 13A, 13B of both streams X and Y.

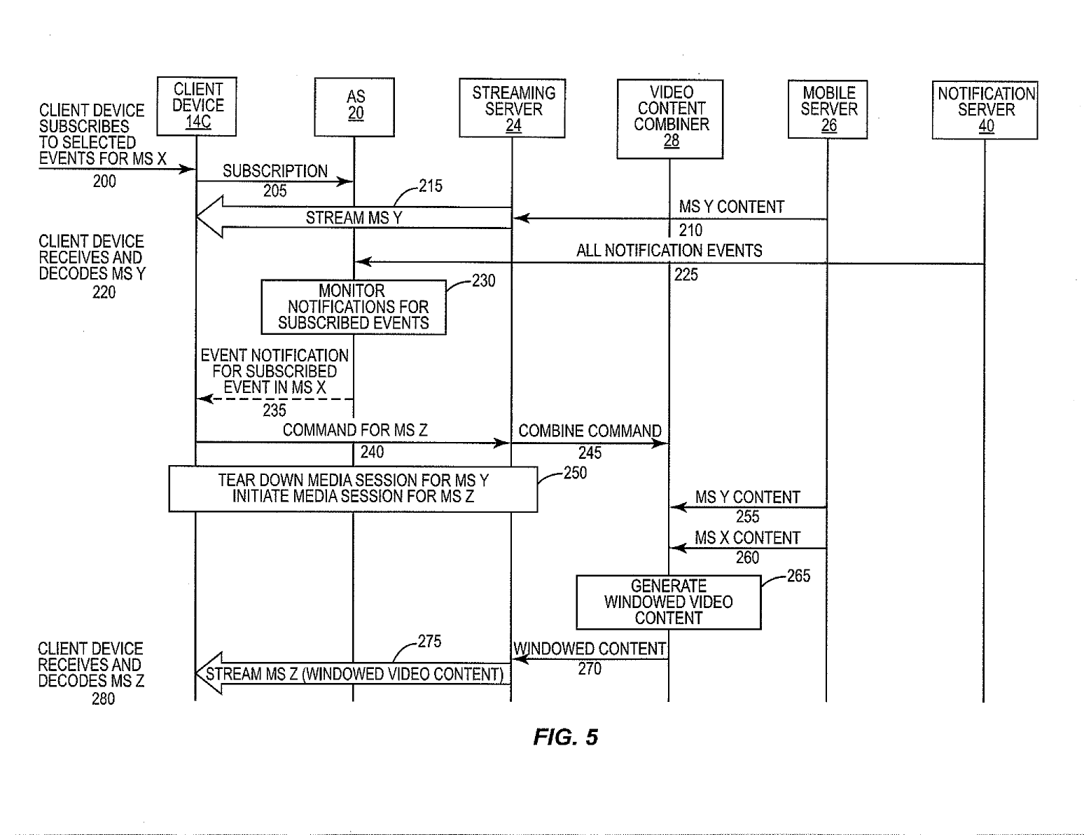

FIG. 5 by contrast depicts an embodiment where the client device 14C actually triggers streaming of stream Z, even though the AS 20 stores the subscription for the device 14C. That is, the client device 14C in this embodiment comprises the apparatus depicted in FIG. 2, but the device 14C does not store subscription 36 in its memory 34. Instead, the AS 20 stores the subscription 36 and selectively notifies the device 14C of the occurrence of defined events to which the device 14C is subscribed. The device 14C then triggers streaming of stream Z responsive to such notification.

Specifically, the steps in FIG. 5 correspond to those in FIG. 4, with a few exceptions. Instead of the AS 20 autonomously directing the streaming server 24 to deliver stream Z to the client device 14C responsive to receiving notification of an event to which the device 14C has subscribed, the AS 20 selectively forwards or otherwise indicates that notification to the device 14C (Step 235). That is, the AS 20 receives notification of the occurrence of all defined events, but only notifies the client device 14C of the events to which the device 14C is subscribed. The device 14C, not the AS 20, then actually sends a command to the streaming server 24 that directs the server 24 to deliver windowed video content 13C (i.e., stream Z) to the client device 14C (Step 240). As compared to the embodiment in FIG. 5, this simplifies operation of the AS 20 and insulates the AS 20 from having to track device media sessions.

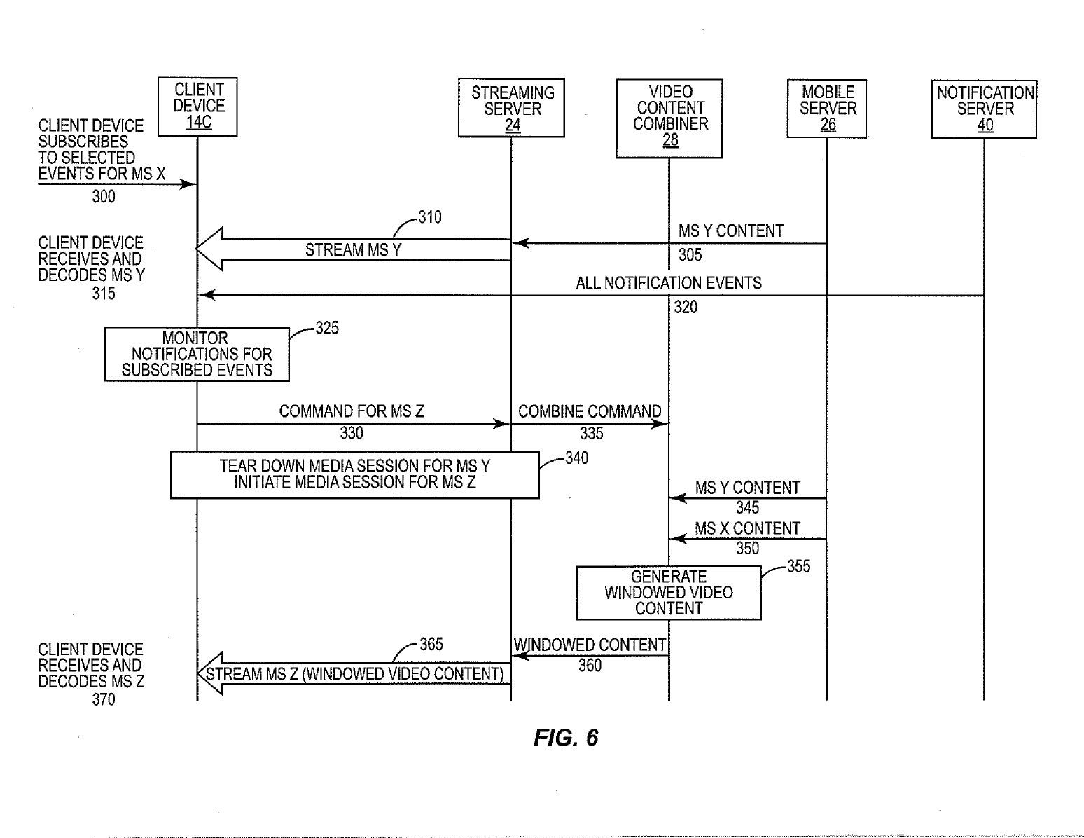

FIG. 6 further simplifies operation of the AS 20 by having the client device 14C store its subscription 36 in memory 34. That is, the client device 14C in this embodiment comprises the apparatus depicted in FIG. 2, and the device 14C does in fact store subscription 36 in memory 34.

As compared to FIG. 5, therefore, the notification server 40 sends all event notifications directly to the client device 14C, not the AS 20 (Step 320). The client device 14C monitors these received notifications in relation to the stored subscription 36 (Step 325). Responsive to a received notification indicating the recent or impending occurrence of one of the defined events of interest to which the client device 14C has subscribed, the device 14C sends a command to the streaming server 24 that directs the server 24 to deliver windowed video content 13C (i.e., stream Z) to the client device 14C (Step 330).

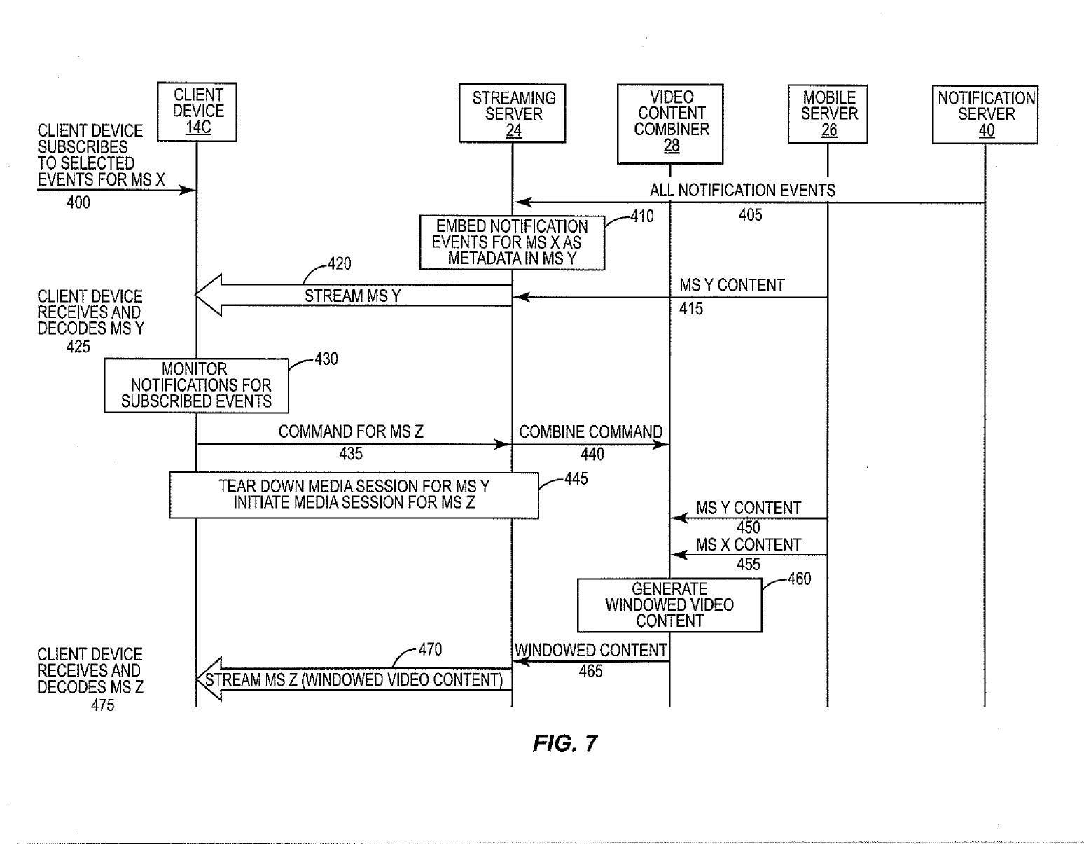

FIG. 7 now illustrates a slightly different embodiment. In this embodiment, the client device 14C still stores its subscription 36 in memory 34 and monitors received notifications in relation to that stored subscription 36. But the device 14C receives these notifications from the streaming server 24 as metadata within stream Y, rather than as push notifications from the notification server 40.

More particularly, the streaming server 24 in this embodiment is configured to receive event notifications for stream X from the notification server 40 (Step 405). As these notifications are received, the streaming server 24 embeds the notifications as metadata within stream Y (Step 410). The client device 14C is correspondingly configured, as the device 14C receives and decodes stream Y, to monitor for and extract these notifications from stream Y's metadata. With the notifications extracted in this way, the client device 14C monitors the notifications in relation to the stored subscription 36 in much the same way as discussed above.

Note of course that the streaming server 24 in this embodiment has no knowledge of the device's subscription 36, and thus is configured to embed notifications of all events, for all multicast streams available from the content provider 12 (i.e., not just stream X), in stream Y's metadata.

While the above description has focused primarily on ensuring that the windowed video content 13C is triggered at the right time, and actually contains video content of the defined event that is of interest to the device's user, note that the windowed video content 13C can be customized in a number of different respects. In some embodiments, for example, the AS 20 or client device 14C is configured to send a customization command to the streaming server 24 that controls the arrangement or position of the video content 13A and 13B within the windowed video content 13C. The customization command may for instance specify where in the windowed video content 13C a window of stream X's video content 13A is to be positioned (e.g., in the lower-left corner, the lower-right corner, etc.). Alternatively or additionally, the customization command may specify the size of the windows for the respective streams' video content 13A, 13B (e.g., the window for stream X's video content 13A is to be smaller than the window for stream Y's video content 13B).

Moreover, this customization command may be generated by the AS 20 or client device 14C as specified by the device's subscription 36. The subscription 36 may even trigger different customization commands for different events of interest, meaning that the customization commands may be event-specific. For example, the subscription 36 may specify that an event-triggered window of a hockey goal scored in the first period is to be smaller than a window of a currently watched movie. The subscription 36 may complement this rule by specifying that an event-triggered window of a hockey goal scored in the last minute of the game is to be larger than a window of the currently watched movie.

Customization commands may alternatively or additionally relate to the audio content of the stream Z, not just the stream's video content 13C. In this regard, customization commands may specify whether audio content of stream Z is to comprise audio content of stream X or audio content of stream Y. Such commands may also be event-specific. Regardless, the streaming server 24 is configured to select stream Z's audio content in accordance with such customization commands.

Note that such customization commands may be sent when initially directing the streaming server 24 to deliver stream Z, but may alternatively or additionally be sent later, after streaming of stream Z has already begun. When sent during streaming of stream Z, the streaming server 24 is configured to dynamically adjust generation of the stream's audio and/or video content in accordance with the received commands.

In a somewhat similar manner, the AS 20 or client device 14C may be configured to send control commands to the streaming server 24 once streaming of stream Z has begun. Such control commands, at least from the client device's perspective, provide independent playback control of the content 13A and 13B at the client device 14C. For instance, the control commands may rewind, pause, or fast forward playback of stream X's content 13A, while independently providing such functionality with respect to stream Y's content 13B. Of course, in actuality, the control commands instruct the video content combiner 28 on how to combine the content 13A and 13B for generating stream Z's windowed video content 13C. In some embodiments, for instance, a control command independently controls a point in stream X or Y at which video content 13A or 13B is obtained by the video content combiner 28 for dynamic generation of stream Z's windowed video content 13C.

Finally, the AS 20 or client device 14C may be configured to send control commands that selectively direct the streaming server 24 to either switch back to streaming stream Y or begin streaming stream X instead. These control commands may be generated responsive to user input, or may be pre-configured in the subscription 36. Such pre-configured commands may be event-specific. For example, the subscription 36 may specify that the streaming server 24 is to switch back to streaming stream Y's movie after expiration of a pre-determined period of time. The subscription 36 may specify this action, for instance, for goals scored during the first period of a hockey game, but may suppress this action for goals scored in the last five minutes of the game.

Note that while the above embodiments have focused discussion on the combination of multimedia content from only two multicast streams, embodiments are equally applicable to any number of such multicast streams. In fact, the efficiency of the embodiments increases in many respects as the number of multicast streams grows larger, since the client device 14C may receive the multimedia content from multiple streams by only receiving a single stream.

Also note that the above embodiments have depicted the streaming server 24, the video content combiner 28, and the media server 26 as being implemented in different physical nodes. However, those skilled in the art will readily appreciate that any of these entities may be implemented in the same or different physical nodes.

Those skilled in the art will also appreciate that while the embodiments have depicted the system 10 as being an IMS-based solution, the embodiments herein equally apply to a pure IP solution. Further in this regard, no particular communication interface standard is necessary for practicing the present invention. For example, the delivery network 18 may comprise any one of more of a packet data network (e.g., the Internet) and a wireless access network (e.g., a Wideband CDMA (WCDMA) access network, a CDMA2000 access network, or the like).

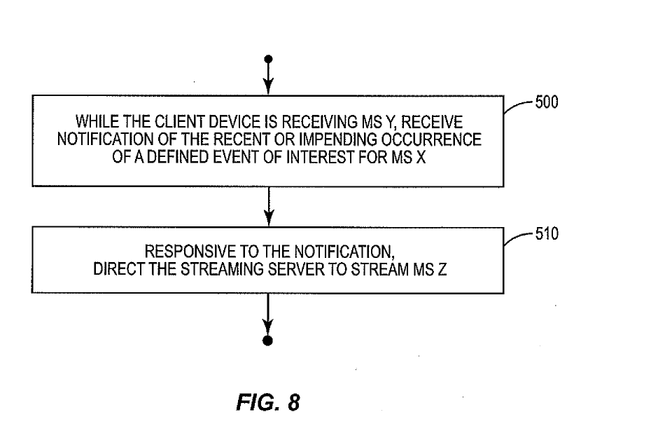

With the above variations and modifications in mind, those skilled in the art will appreciate that the apparatus in FIG. 2 (i.e., the AS 20 or the client device 14C) is generally configured to perform the processing illustrated in FIG. 8. In FIG. 8, processing includes, while the client device 14C is receiving multicast stream Y from the streaming server 24, receiving notification of the recent or impending occurrence of a defined event of interest characteristic of the multimedia content 13A in multicast stream X (Step 500). Processing then includes, responsive to receiving that notification, directing the streaming server 24 to stream to the client device 14C a stream Z whose video content comprises windowed video content 13C of both streams X and Y (Step 510).

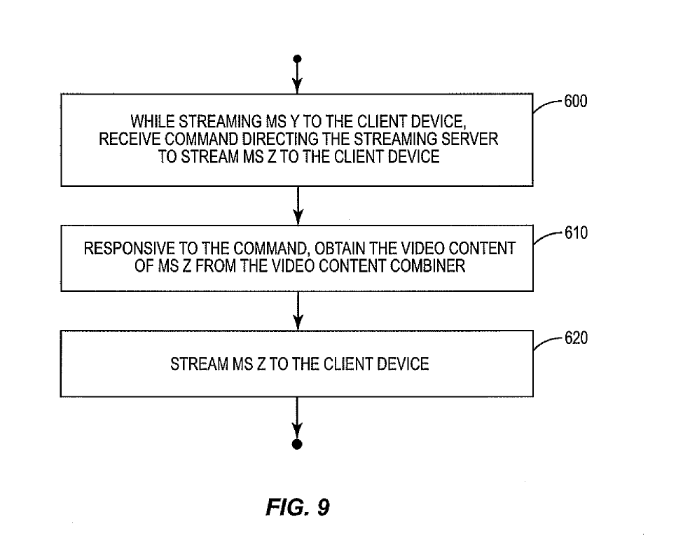

Those skilled in the art will also appreciate that the streaming server 24 is correspondingly configured to perform the processing illustrated in FIG. 9. In FIG. 9, processing includes, while streaming stream Y, but not stream X, to the client device 14C, receiving a command that directs the streaming server 24 to stream to the client device 14C a stream Z whose video content comprises windowed video content 13C of both streams X and Y (Step 600). Processing then includes, responsive to the command, obtaining the video content of stream Z from the video content combiner 28 (Step 610) and streaming stream Z to the client device 14C (Step 620).

Those skilled in the art will further appreciate that the various “circuits” described may refer to a combination of analog and digital circuits, including one or more processors configured with software stored in memory and/or firmware stored in memory that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method for coordinating streaming of multimedia content from a streaming server to a client device, comprising:
while the client device is receiving a first multicast stream from the streaming server, receiving notification of a recent or impending occurrence of a defined event of interest characteristic of the multimedia content in a second multicast stream; and
responsive to receiving said notification, directing the streaming server to stream to the client device a third stream whose video content comprises windowed video content of both the first and second multicast streams.

2. The method of claim 1, wherein the third stream is a unicast stream.

3. The method of claim 1, further comprising instructing the streaming server that said windowed video content is to include either recorded or real-time video content of the second multicast stream depending respectively on whether said notification indicates the recent or impending occurrence of said defined event.

4. The method of claim 1, further comprising directing the streaming server as to whether audio content of the third stream is to comprise audio content of the first multicast stream or audio content of the second multicast stream.

5. The method of claim 1, further comprising sending to the streaming server a command that independently controls a point in the first or second multicast stream at which video content is obtained for dynamic generation of said windowed video content.

6. The method of claim 1, wherein one or more trigger rules condition performance of said directing on at least one of:
a classification of the multimedia content being streamed to the client device when said notification is received;
a classification of the multimedia content associated with the notification; and
a time at which said notification is received.

7. The method of claim 1, wherein the method is implemented by an application server that serves a plurality of client devices, and wherein the method further comprises:
if at least a threshold number of client devices have indicated interest in the defined event associated with said notification and are also receiving the first multicast stream from the streaming server, directing the streaming server to stream the third stream to the client device as a multicast stream; and
otherwise, directing the streaming server to stream the third stream to the client device as a unicast stream.

8. A method implemented by a streaming server for streaming multimedia content to a client device, comprising:
while streaming a first, but not a second, multicast stream to the client device, receiving a command that directs the streaming server to stream to the client device a third stream whose video content comprises windowed video content of both the first and second multicast streams;
responsive to the command, obtaining the video content of the third stream from a video content combiner; and
streaming the third stream to the client device.

9. The method of claim 8, wherein said streaming comprises streaming the third stream to the client device as a unicast stream.

10. The method of claim 8, wherein said streaming comprises:
if the streaming server has been commanded to stream the third stream to at least a threshold number of client devices served by the streaming server, streaming the third stream to said client device as a multicast stream; and
otherwise, streaming the third stream to the client device as a unicast stream.

11. The method of claim 8, further comprising receiving a control command that indicates whether said windowed video content is to include recorded or real-time video content of the second multicast stream.

12. The method of claim 8, further comprising receiving a control command that independently indicates a point in the first or second multicast stream at which video content is to be obtained for dynamic generation of said windowed video content, and wherein said obtaining comprises directing the video content combiner to dynamically generate the windowed video content from the first and second multicast streams in accordance with the received control command.

13. The method of claim 8, further comprising selecting audio content of the third stream to comprise either audio content of the first multicast stream or audio content of the second multicast stream, in accordance with a received control command.

14. An apparatus for coordinating streaming of multimedia content from a streaming server to a client device, comprising:
a notification monitor configured, while the client device is receiving a first multicast stream from the streaming server, to receive notification of a recent or impending occurrence of a defined event of interest characteristic of the multimedia content in a second multicast stream; and
a stream controller configured, responsive to the notification monitor receiving said notification, to direct the streaming server to stream to the client device a third stream whose video content comprises windowed video content of both the first and second multicast streams.

15. The apparatus of claim 14, wherein the stream controller is further configured to instruct the streaming server that said windowed video content is to include either recorded or real-time video content of the second multicast stream depending respectively on whether said notification indicates the recent or impending occurrence of said defined event.

16. The apparatus of claim 14, wherein the stream controller is further configured to direct the streaming server as to whether audio content of the third stream is to comprise audio content of the first multicast stream or audio content of the second multicast stream.

17. The apparatus of claim 14, wherein the stream controller is further configured to send to the streaming server a command that independently controls a point in the first or second multicast stream at which video content is obtained for dynamic generation of said windowed video content.

18. The apparatus of claim 14, wherein the stream controller is configured, in accordance with one or more trigger rules, to condition performance of said directing on at least one of:
a classification of the multimedia content being streamed to the client device when said notification is received;
a classification of the multimedia content associated with the notification; and
a time at which said notification is received.

19. The apparatus of claim 14, wherein the apparatus comprises an application server that serves a plurality of client devices, and wherein the stream controller is configured to:
if at least a threshold number of client devices have indicated interest in the defined event associated with said notification and are also receiving the first multicast stream from the streaming server, direct the streaming server to stream the third stream to the client device as a multicast stream; and
otherwise, direct the streaming server to stream the third stream as a unicast stream.

20. A streaming server configured to stream multimedia content to a client device, comprising:
a stream controller configured, while the streaming server is streaming a first, but not a second, multicast stream to the client device, to receive a command that directs the streaming server to stream to the client device a third stream whose video content comprises windowed video content of both the first and second multicast streams;
a content controller configured, responsive to the command, to obtain the video content of the third stream from a video content combiner; and
a communications interface configured to stream the third stream to the client device.

21. The streaming server of claim 20, wherein the communications interface is configured:
if the streaming server has been commanded to stream the third stream to at least a threshold number of client devices served by the streaming server, to stream the third stream to said client device as a multicast stream; and
otherwise, to stream the third stream to the client device as a unicast stream.

22. The streaming server of claim 20, wherein the stream controller is further configured to receive a control command that indicates whether said windowed video content is to include recorded or real-time video content of the second multicast stream, and wherein the content controller is configured to direct the video content combiner to generate the windowed video content in accordance with that control command.

23. The streaming server of claim 20, wherein the stream controller is further configured to receive a control command that independently indicates a point in the first or second multicast stream at which video content is to be obtained for dynamic generation of said windowed video content, and wherein said content controller is configured to direct the video content combiner to dynamically generate the windowed video content from the first and second multicast streams in accordance with the received control command.

24. The streaming server of claim 20, wherein the content controller is further configured to select audio content of the third stream to comprise either audio content of the first multicast stream or audio content of the second multicast stream, in accordance with a received control command.
